(19) United States
(12) Patent Application Publication
(10) Pub. No.: US 2016/0273735 A1
(43) Pub. Date: Sep. 22, 2016

(54) PART OF A LED SYSTEM

(71) Applicant: DSM IP ASSETS B.V., Heerlen (NL)

(72) Inventors: Augustinus Gregorius Henricus MEIJERS, Echt (NL); Siva Esakimuthu SUBRAMONIAN, Echt (NL)

(21) Appl. No.: 15/034,229

(22) PCT Filed: Nov. 19, 2014
(86) PCT No.: PCT/EP2014/075020

§ 371 Date: May 4, 2016

(30) Foreign Application Priority Data
Nov. 28, 2013 (EP) 13194812.7

(51) Int. Cl. F21V 7/22; F21V 7/04; F21K 99/00

(52) U.S. Cl. CPC F21V 7/22; F21K 9/54; F21V 7/043; F21Y 2101/02

(57) ABSTRACT

Part of a LED system, the part being exposed to LED light, particular the reflector for a LED (light Emitting Diode) system, more particular the reflector for a mixing chamber of a LED system, which the part consists of a polymer composition comprising a polyester and a white pigment, which polyester has been solid state post condensated.

The inventions relates to a part of a LED system, the part being exposed to LED light, particularly a reflector for a LED system, more particularly a reflector for a mixing chamber of a LED (light Emitting Diode) system.

LED systems may comprise a mixing chamber defined by a bottom reflector, a side reflector and a remote phosphor plate. LED's are in general mounted in the bottom reflector of the mixing chamber. Normally a LED produces blue light that is reflected by the side reflector and the bottom reflector and so transmitted through the remote phosphor plate, wherein the blue light is transformed into white light.

To obtain for instance a high luminous efficacy of the LED system, it is important that the reflectors for the LED system are of a highly reflective material. Known is a mixing chamber comprising a bottom and side reflector of a ceramic material. Ceramic materials are often chosen because of the high temperatures that occur in the mixing chamber, during use of the LED system. Furthermore the reflectors have an intense white color and a high reflectivity.

A disadvantage of such reflectors is however that their production process is complicated, so that the cost price of the reflectors is high. Furthermore the possibility to integrate parts in the reflector is limited. For that reasons attempts have been made to produce the reflectors, but also other parts of a LED system being exposed to LED light, of a polymeric material. However it appeared that the thermo-resistance of the polymeric material was insufficient to withstand the high temperatures of up to 80° C. or sometimes even up to 120° C., resulting for instance in loss of reflectivity during the use of the LED system in case of reflectors. It also appeared that polymeric materials discolor when they are exposed to LED light.

In WO2013/135827 a part of a LED system, the part being exposed to LED light has been described that consists of a polymer composition comprising a polyester and a white pigment.

The part according to WO2013/135827 has a good resistance against the high temperatures.

However there is a need for a part of a LED system with a further improved resistance against high temperatures.

Surprisingly this object is obtained if the part consists of a polymer composition comprising a polyester and a white pigment, which polyester has been subjected to a solid state post condensation (SSPC).

The polyester may be polyethylene terephthalate, polybutylene terephthalate or polycyclohexylene terephthalate. Preferably the polyester is polyethylene terephthalate and/or polybutylene terephthalate, most preferably polybutylene terephthalate.

### A. PBT.

Polybutylene terephthalate (PBT) may be produced from the polycondensation reaction of butane diol and terephthalic acid and/or the methyl ester of terephthalic acid.

### B. PET.

Polyethylene terephthalate PET may be produced from the polycondensation reaction of ethylene diol and terephthalic acid and/or the methyl ester of terephthalic acid. PBT and PET may comprise minor amounts, for example up to 5 wt. % of further monomer units, for example monomeric units of further alkylene diols and aromatic dicarboxylic acids.

The polymer composition comprises a white pigment. Examples of white pigments include titanium dioxide, zinc sulfide, zinc oxide, barium sulfate and potassium titanate. Preferably titanium dioxide is used.

Preferably the composition contains at least 20 wt. %, more preferably at least 25 wt. % of the white pigment. Preferably the composition contains at most 35 wt. % of the white pigment.

Sold state post condensation is preferably carried out after compounding of the polymer composition. This is because during solid state post condensation the molecular weight of the polyester and thus the viscosity of the polymer composition increases. This makes it more difficult to obtain a homogeneous polymer composition.

For the compounding of the polymer composition any customary compounding process may be used. Suitably, the polymer composition is compounded by melt blending the various components in a melt-mixing device. Suitable melt mixing devices are, for example, extruders, especially twin-screw extruders, most preferably with co-rotating screws.

The polymeric constituents and other components may be first mixed as a dry blend and then fed to the melt mixing device. Suitably a reinforcing fibre is added after the polymer melt has been formed.

To subject the polyester to SSPC, the polymer composition obtained after compounding is subjected to a heat-treatment, preferably at a temperature close to, but below the melting point of the polymer composition (e.g. from about 50° C. to 10° C. below), and under reduced pressure or a flow of an inert gas. For embodiments in which the polymer is PBT, the heat treatment preferably heats and maintains the polyester composition at a temperature between 160° C. and 190° C., more preferably between 175° C. and 185° C. The advantage of a higher temperature is that the process runs faster.

Preferably the inert gas atmosphere has a pressure of less than 10 kPa, more preferably less than 1 kPa, even more preferably less than 500 Pa. A lower pressure has the advantage that the process runs faster. This allows a more efficient production process with a higher yield, without the need of extending the production installation.

The SSPC of the polyester may be carried out by any mode and in any apparatus suitable for that purpose. The process can suitably be carried out, for example, as a batch process (e.g. in a tumble dryer) or as a continuous process (e.g. in a moving bed reactor).

Preferably the composition comprises:

the polyester
10-40 wt. % of the white pigment
at least 5 wt. % of a halogen free flame retardant system.
The flame retardant system preferably contains:
5-20 wt. % metal phosphinate
0-10 wt. % synergist for the metal phosphinate.

The halogen free flame retardant system may consist of only one component, it also may comprise more than one component, for example two different flame retardants, or a flame retardant and a synergist, and/or an anti-dripping agent.

Metal phosphinates include metal salts of phosphinic acids and/or diphosphinic acids or polymeric derivatives thereof.

Suitably, the metal phosphinate is a metal of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein

R¹ and R² are equal or different substituents chosen from the group consisting of hydrogen, linear, branched and cyclic C1-C6 aliphatic groups, and aromatic groups,

R³ is chosen from the group consisting of linear, branched and cyclic C1-C10 aliphatic groups and C6-C10 aromatic and aliphatic-aromatic groups,

M is a metal chosen from the group consisting of Mg, Ca, Al, Sb, Sn, Ge, Ti, Zn, Fe, Zr, Ce, Bi, Sr, Mn, Li, Na, and K, and

m, n and x are equal or different integers in the range of 1-4.

Suitable metal phosphinates that can be used as component B in the present invention are described for example in DE-A 2 252 258, DE-A 2 447 727, PCT/W-097/39053 and EP-0932643-B1. Preferred phosphinates are aluminium-, calcium- and zink-phosphinates, i.e. metal phosphinates wherein the metal M=Al, Ca, Zn respectively, and combinations thereof. Also preferred are metal phosphinates wherein R¹ and R² are the same or different and are equal to H, linear or branched C₁-C₆-alkyl groups, and/or phenyl. Particular preferably, R¹, R² are the same or different and are chosen from the group consisting of hydrogen (H), methyl, ethyl, n-propyl, iso-propyl, n-butyl, tert.-butyl, n-pentyl and phenyl. More preferably, R¹ and R² are the same or different and are chosen from the group of substituents consisting of H, methyl and ethyl.

Also preferably R³ is chosen from the group consisting of methylene, ethylene, n-propylene, iso-propylene, n-butylene, tert.-butylene, n-pentylene, n-octylene, n-dodecylene, phenylene and naphthylene.

Highly preferably, the metal phosphinate comprises a hypophosphate and/or a C₁-C₂ dialkylphosphinate, more preferably Ca-hypophosphate and/or an Al—C₁-C₂ dialkylphosphinate, i.e. Al-dimethylphosphinate, Al-methylethylphosphinate and/or Al-diethylphosphinate. Most preferably Al-diethylphosphinate (DEPAL) is used.

Preferably the composition contains at least 7.5 wt. %, more preferably at most 10 wt. % of the metal phosphinate. Preferably the composition contains at most 17.5, more preferably at most 15 wt. % of the metal phosphinate.

Synergists include nitrogen containing and nitrogen/phosphor containing compounds. Examples of suitable compounds include any nitrogen or nitrogen and phosphor containing compound that itself is a flame retardant. Suitable nitrogen containing and nitrogen/phosphor containing compounds that can be used as component synergist are described, for example in PCT/EP97/01664, DE-A-197 34 437, DE-A-197 37 72, and DE-A-196 14 424.

Preferably, the nitrogen containing synergist is chosen from the group consisting of benzoguanamine, tris(hydroxyethyl)isocyanurate, allantoine, glycouril, melamine, melamine cyanurate, dicyandiamide, guanidine and carbodiimide, and derivatives thereof.

More preferably, the nitrogen containing synergist comprises a condensations product of melamine. Condensations products of melamine are, for example, melem, melam and melon, as well as higher derivatives and mixtures thereof. Condensations products of melamine can be produced by a method as described, for example, in PCT/WO 96/16948.

Preferably, the nitrogen/phosphor containing synergist is a reaction product of melamine with phosphoric acid and/or a condensation product thereof. With the reaction product of melamine with phosphoric acid and/or a condensation product thereof are herein understood compounds, which result from the reaction of melamine or a condensation products of melamine are, for example, melem, melam and melon, with a phosphoric acid.

Examples include dimelaminephosphate, dimelamine pyrophosphate, melamine phosphate, melamine polyphosphate (MPP), melamine pyrophosphate, melamine polyphosphate, melam polyphosphate, melon polyphosphate and melem polyphosphate, as are described for example in PCT/WO 98/39306. More preferably the nitrogen/phosphor containing synergist is melamine polyphosphate.

Also preferably, the nitrogen/phosphor containing synergist is a reaction product of ammonia with phosphoric acid or a polyphosphate modification thereof. Suitable examples include ammonium hydrogenphosphate, ammonium dihydrogenphosphate and ammonium polyphosphate. More preferably the nitrogen/phosphor containing synergist comprises ammonium polyphosphate.

Preferably the synergist is a phosphate compound, more preferably a melamine phosphate compound, most preferably a melamine polyphosphate.

The composition according to the invention contains preferably between 3 and 15 wt. %, more preferably between 6 and 10 wt. % of the synergist. In this way a high level of flame retardancy has been obtained.

The composition according to the invention may suitably comprise one or more additives.

Suitable additives include stabilizers, such as antioxidants, UV-absorbers and heat stabilizers, impact modifiers, plasticizers, lubricants, emulsifiers, nucleating agents, fillers, pigments, optical brighteners, further flame retardants, and antistatic agents. Suitable fillers are, for example, calcium carbonate, silicates and talcum.

In a preferred embodiment of the invention the flame retardant thermoplastic composition of the reflector comprises one or more additives in a total amount of 0.01-20 wt. %, more preferably 0.1-10 wt. %, still more preferably 0.2-5 wt. %, or even 0.5-2 wt. % relative to the total weight of the flame retardant thermoplastic composition.

Preferably the composition comprises an impact modifier. Not only because the brittleness decreases, but also because the elongation at break increases. More preferably an impact modifier based on acrylate rubber is used, most preferably an impact modifier based on an acrylate/siloxane rubber, preferably an epoxy modified acrylate/siloxane rubber. With this impact modifier the best retention of light reflection at high temperatures is obtained.

Preferably the composition contains a nucleating agent. Such a composition shows a further improved retention of light reflection at high temperatures. Examples of suitable impact modifiers include sodium benzoate and micro-talcum. Preferably micro-talcum is used.

Good results are obtained if the reflector according to the invention is a bottom reflector or a side reflector of a mixing chamber of a LED system, as well as a LED packaging.

It is also possible that the reflector according to the invention is a reflector of a lamp for use in an automobile, or for use inside a building.

Also good results are obtained if the reflector according to the invention is a reflector of a backlight, preferably the back light of a mobile phone, smart phone, e-reader, tablet etc.

The invention is further explained in the Figure, without being restricted to that.

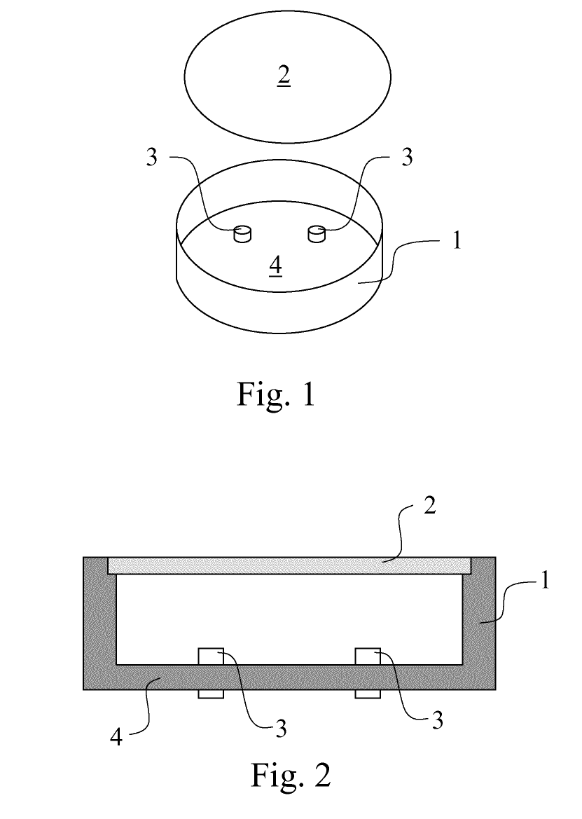

FIG. 1 shows a schematic view of a mixing chamber of a LED system.

FIG. 2 shows an intersection of the mixing chamber of FIG. 1.

The mixing chamber of FIG. 1 is defined by the side reflector (1), the bottom reflector (4) and the remote phosphor plate (2) that is lifted from the side reflector to provide a view inside the mixing chamber. In the bottom reflector 4 LED's are mounted, of which 2 LED's (3) are visible.

FIG. 2 shows an intersection of the mixing chamber of FIG. 1. The remote phosphor plate (2) is in its position on top of the mixing chamber. The side reflector (1) and the bottom reflector (4) are integrated into one molded part. Also shown are the LED's (3).

The invention is further explained by the examples, without being restricted to that.

### Materials Used:

PBT: polybutylene terephthalate, having a relative solution viscosity (RSV) of 1.90 (determined by diluting 1 gram of polymer in 125 grams of solvent at 25° C., the solvent consisting of 7.2 parts by weight 2,4,6 trichlorophenol and 10 parts by weight phenol). —TiO₂: R105, tanium dioxde, delivered by Dupont in Belgium.

Nucleating agent: micro talcum, Talc MP1250™, delivered by Barrels Minerals Co.

Flame retardant: DEPAL, Exolit 1230™, delivered by Clariant.

Synergist: MPP, Budit 3141™, delivered by Budenheim.

### Measurement of the Reflectivity.

The reflection was measured according to ISO 7724-1-2, using a Minolta™ CM3700d spectrometer, at an angle of 460 nm.

### Measurement of the Elongation at Break.

The elongation at break is measured according to ISO 527, with a pulling speed of 5 mm/min.

### COMPARATIVE EXPERIMENT A

A dry blend of a mixture comprising:

### 60.4 wt. % of PBT,

13.3 wt. % of flame retardant,
6.5 wt. % of synergist and

### 20.2 wt. % of TiO2

was prepared in a tumbler and granulated at a co-rotating twin screw extruder. Thereafter the granulate was injection molded in plaques of 80*80*2 mm. The reflectivity and the elongation at break were measured at the initial samples and at the samples after 2000 hours of accelerated aging at 120 and 140° C. The results are given in Table 1.

### EXAMPLE I

As comparative experiment A, however after granulation of the mixture at the co-rotating extruder, for SSPC the granulate was subjected to a heat treatment at 185° C., for 10 hours in a tumble dryer under a nitrogen atmosphere. The results are given in table 2.

### EXAMPLE II

As example I, however the composition contained 20 wt. % of TiO2 and 0.2 wt. % of nucleating agent. The results are presented in table 2.

TABLE 1

| | | Before SSPC | | Reflection drop | Reflection drop |
|---|---|---|---|---|---|
| | | Initial | | at 460 nm [%] | at 460 nm [%] |
| | | Reflection | Elongnation | in 2000 hrs@120 | in 2000 hrs@140 |
| Description | Samples | at 460 nm [%] | atBreak | Deg C. | Deg C. |
| without | Comp.Ex A | 95.00 | 1.4 | 3 | 8 |
| nucleating | | | | | |

TABLE 2

| | | after SSPC | | | |
|---|---|---|---|---|---|
| | | | | Reflection drop | Reflection drop |
| | | Initial | | at 460 nm [%] | at 460 nm [%] |
| | | Reflection | Elongnation | in 2000 hrs@120 | in 2000 hrs@140 |
| Description | Samples | at 460 nm [%] | atBreak | Deg C. | Deg C. |
| without | Example I | 95.00 | 1.8 | 2.5 | 7 |
| nucleating | | | | | |
| With | Example II | 95.00 | 1.9 | 1.5 | 4 |
| nucleating | | | | | |

1. Part of a LED system, the part being exposed to LED light, which part consists of a polymer composition comprising a polyester and a white pigment, characterized in that the polyester has been solid state post condensated.

2. Part according to claim 1, wherein the polyester is polybutylene terephthalate.

3. Part according to claim 1, wherein the white pigment is titanium dioxide, zinc sulfide, zinc oxide, barium sulfate and potassium titanate.

4. Part according to claim 1, wherein the white pigment is titanium dioxide.

5. Part according to claim 1, wherein the polymer composition contains:
the polyester
15-40 wt. % of the white pigment
at least 5 wt. % of a halogen free flame retardant system.

6. Part according to claim 1, wherein the composition contains:
5-20 wt. % metal phosphinate
0-10 wt. % synergist for the metal phosphinate.

7. Part according to claim 1, wherein the composition contains an impact modifier.

8. Part according to claim 7, wherein the composition contains a nucleating agent.

9. Part according to claim 1, characterized in that the part is a reflector for a LED system.

10. Part according to claim 9, wherein the reflector is a side reflector for a mixing chamber of a LED system.

11. Part according to claim 10, wherein the side reflector is integrated with the bottom reflector into one molded part.
